(19) United States
(12) Patent Application Publication
(10) Pub. No.: US 2017/0361490 A1
(43) Pub. Date: Dec. 21, 2017

(54) PROCESS FOR MANUFACTURING A CERAMIC TURBINE BLADE

(71) Applicant: SAFRAN POWER UNITS, Toulouse (FR)

(72) Inventors: Emilie HERNY, Toulouse (FR); Jean-Francois RIDEAU, Tournefeuille (FR); Moataz ATTALLAH, Birmingham (GB); Gang LIU, Chongqing (CN); Tim BUTTON, Redditch (GB); Yun JIANG, Birmingham (GB)

(73) Assignee: SAFRAN POWER UNITS, Toulouse (FR)

(21) Appl. No.: 15/524,166

(22) PCT Filed: Nov. 3, 2015
(86) PCT No.: PCT/FR2015/052953

§ 371 Date: May 3, 2017

(30) Foreign Application Priority Data
Nov. 4, 2014 (FR) 1402492

(51) Int. Cl. B28B 7/34; B28B 1/00; F01D 5/28; B28B 1/24; B22D 19/00; B22C 9/04

(52) U.S. Cl. CPC B28B 7/346; B28B 1/24; B22D 19/00; B28B 1/001; F01D 5/284; B22C 9/04; F05D 2230/21; F05D 2300/21

(57) ABSTRACT

A method of fabricating a ceramic turbine blade, the method includes selective melting on a powder bed in order to obtain a blade mold cavity in a mold, a ceramic-based suspension is provided, the suspension is introduced into the blade mold cavity, the suspension is subjected to a gelation step in the mold cavity in order to obtain a blade suitable for being extracted from the mold cavity, and the blade is extracted from the mold cavity.

The present invention relates to a method of fabricating a ceramic turbine blade.

Turbine blades, in particular those for the turbines of turboshaft aircraft engine, need to satisfy numerous requirements. In particular, they must be capable of withstanding temperatures that are very high, possibly exceeding 1600 kelvins (K), and they are of shapes that are complex and also require great accuracy, and therefore require fabrication tolerances that are small.

It is known to fabricate turbine blades for turboshaft aircraft engines out of metal, thus making it possible to make the desired shapes. Nevertheless, metals cannot withstand temperature gradients of the above-mentioned order without deforming, so it is necessary to provide metal blades with internal cooling systems, which are complex and expensive.

Ceramics are materials that withstand very high temperature gradients, so attempts have been made to make turbine blades out of such materials. Specifically, with blades made of ceramic material, there is no need to provide blade cooling systems, even when the temperatures to which they are subjected reach 1600 K or more.

Nevertheless, since ceramic is not easy to machine, it is difficult with a ceramic-based material to obtain the desired complex shape together with the necessary accuracy while using a method that may be industrialized.

U.S. Pat. No. 5,028,362 relates to fabricating ceramic parts using a gel casting method. In that method, a ceramic-based suspension is cast into a mold, and then polymerized. That patent mentions the possibility of obtaining parts that are complex in shape by using that technique. Nevertheless, the shape of the part fabricated in that way is dictated by the shape of the mold. Thus, if mold fabrication does not comply with constraints that are extremely strict in terms of fabrication tolerances requiring accurate and expensive machining, then the shapes of parts obtained from the mold run the risk of not being sufficiently accurate for applications that are particularly demanding, such as turboshaft aircraft engine turbines.

The invention seeks to propose a method of fabricating a ceramic turbine blade that is substantially free of the above-mentioned drawbacks, and in particular that makes it possible to fabricate ceramic blades of complex shape on an industrial scale and with great accuracy.

This object is achieved by the fact that in order to fabricate a ceramic turbine blade, use is made of a technique of selective melting on a powder bed in order to obtain a blade mold cavity in a mold, a ceramic-based suspension is provided, the suspension is introduced into the blade mold cavity, the suspension is subjected to a gelation step in the mold cavity in order to obtain a blade suitable for being extracted from the mold cavity, and said blade is extracted from the mold cavity.

With the method of the invention, the blade mold cavity may be obtained with a shape that is complex and very accurate. The mold presenting the mold cavity may then be used industrially for fabricating turbine blades by casting a ceramic-based suspension. The blades as obtained in this way present exactly the same shape as the blade mold cavity, which shape is very accurate, as mentioned above. It is thus possible to fabricate turbine blades that withstand very large temperature gradients, with shapes that are complex and very accurate, and without there being any need to make use of complex cooling techniques or corrections of shape.

In a first embodiment, in order to obtain the blade mold cavity, the mold is made directly by selective melting on a powder bed.

Thus, the mold may be fabricated directly as a single piece within which the blade mold cavity is defined as a cavity. For use as a mold, the piece may be cut into at least two mold portions, e.g. by a wire-cutting technique (using a wire and passing an electric current in the wire) or by a high accuracy laser-cutting technique (using a laser beam). The mold portions may be assembled in order to form the mold cavity there between, or they may be separated for unmolding the blade formed in the mold cavity.

It is also possible, from the beginning, to use selective melting on a powder bed to form at least two mold portions suitable for being assembled to form the mold cavity there between, or for being separated for unmolding the blade formed in the mold cavity.

Either way, the mold cavity is formed with very great accuracy and may have the complex shapes required for a turbine blade.

In a second embodiment, in order to obtain the blade mold cavity, a blade model is made by selective melting on a powder bed, a polymer-based paste is cast around the blade model, said paste is caused to harden so as to form a mold block, the mold block is cut to obtain at least two mold portions enclosing the blade model, and said portions are separated in order to extract the blade model from the mold block, so that said portions may be assembled once more in order to form the blade mold cavity there between.

In this second embodiment, it is the blade model that is made by selective melting on a powder bed, and the model is used for fabricating the mold by forming the blade mold cavity in the mold, after which the ceramic blade may be fabricated in the mold. Since the mold is made of a polymer-based paste that is hardened on the blade model, it fits very closely to the shape of the model, such that the shape of the blade mold cavity as obtained in this way in the mold is very accurate. Furthermore, since the mold is made of a polymer-based material, it may be cut in order to form the mold portions by using a laser-cutting technique or a wire-cutting technique, as mentioned above.

Advantageously, after extracting the blade from the mold cavity, said blade is subjected to drying.

Advantageously, after drying, the blade is subjected to sintering.

Advantageously, the ceramic base of the suspension is silicon nitride.

The invention will be well understood and its advantages appear better on reading the following detailed description of embodiments given as non-limiting examples. The description refers to the accompanying drawings, in which:

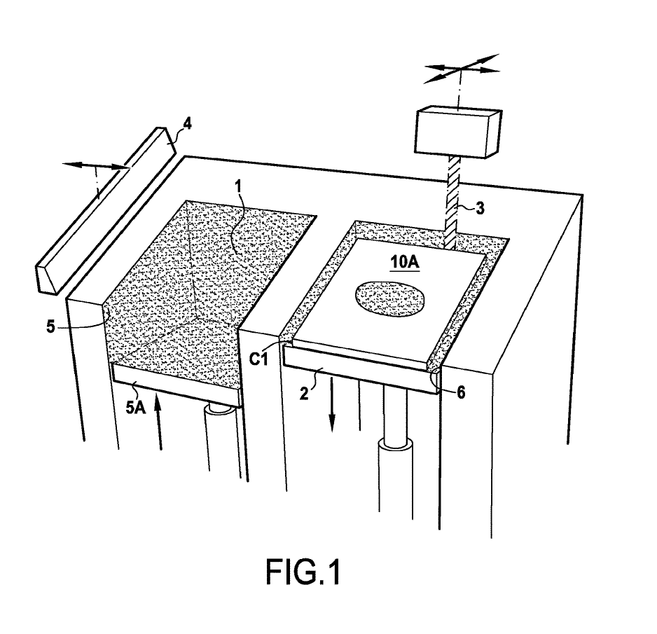

FIG. 1 shows a mold being fabricated by selective melting on a powder bed;

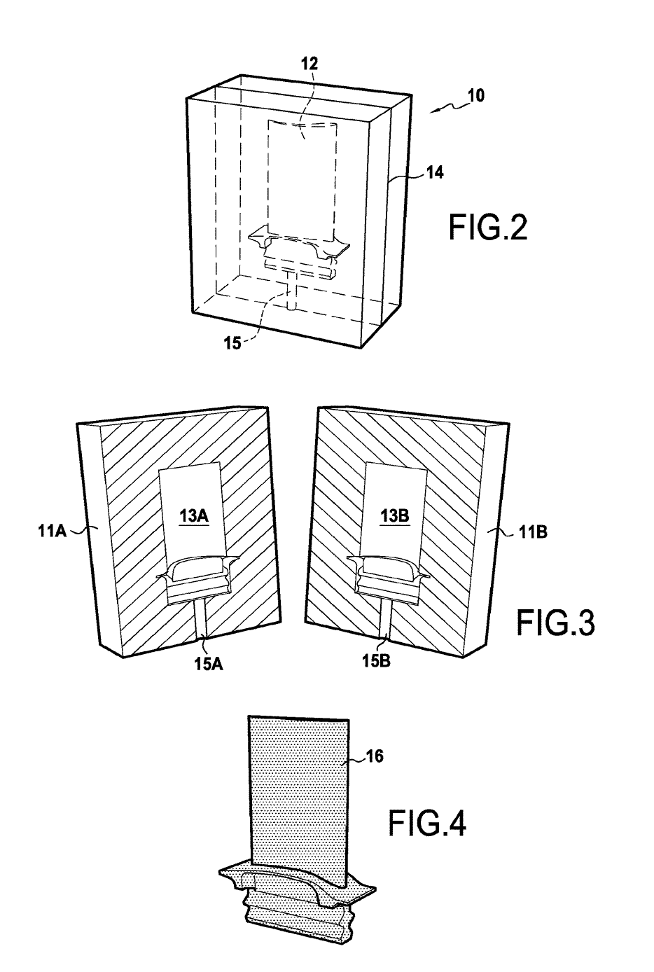

FIG. 2 shows a mold fabricated by selective melting on a powder bed, and having a blade mold cavity;

FIG. 3 shows the mold of FIG. 2 cut into two portions, both portions being open;

FIG. 4 shows a blade fabricated in this mold;

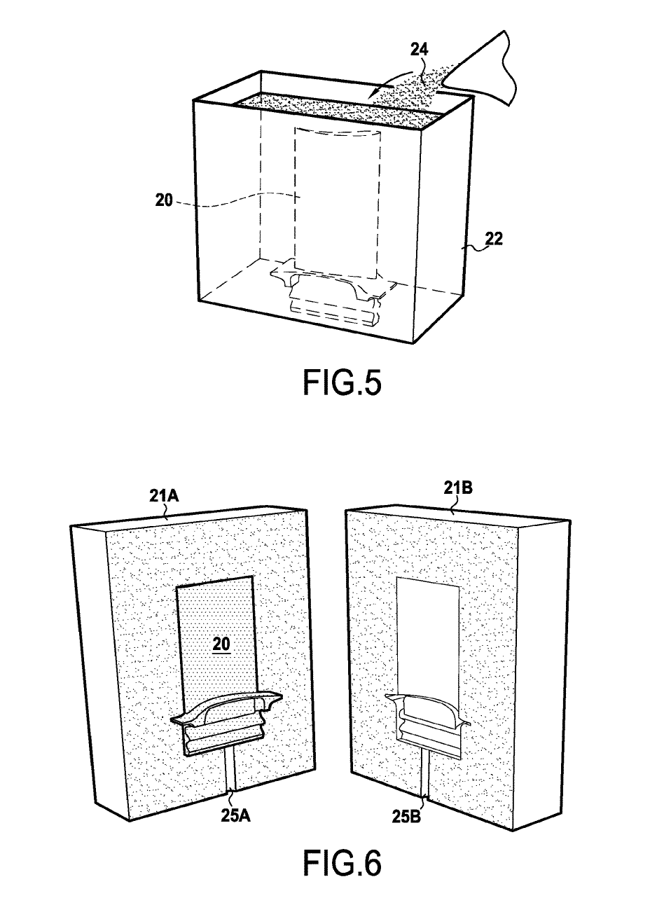

FIG. 5 shows a mold block being fabricated from a blade model fabricated by selective melting on a powder bed; and

FIG. 6 shows this mold block cut into two portions, the blade model remaining secured to one of these portions.

With reference to FIGS. 1 to 4, the description begins with a first embodiment of the invention. FIG. 2 shows a mold 10 in the form of a parallelepiped shape block, having a blade mold cavity 12 inside the block.

The mold is fabricated by selective melting on a powder bed. In that technique, beds of powder are subjected to selective melting or selective sintering by using a high energy beam, in particular a laser beam or an electron beam. More precisely, and as shown in FIG. 1, a material 1 is provided in the form of powder particles and a first layer Cl is deposited on a support 2, with this first layer being scanned selectively by the high energy beam 3 so as to melt the powder precisely along the path followed by the beam on the first layer, so that the melted powder, on solidifying almost instantaneously, forms a first solid mold layer 10A. By using a scraper 4 or the like, a multiplicity of layers of material 1 are deposited in succession on the first layer, and each layer is subjected to a new scan by the beam so as to form successive layers and the non-melted powder is eliminated, until the block shown in FIG. 1 is obtained. For example, the material is initially contained in a chamber 5 having a bottom 5A that rises progressively as the successive layers are deposited so that the scraper 4—may scrape away progressively the powder material and take it to the adjacent chamber 6, above the support 2, which lowers progressively as the successive layers are constructed.

This technique makes it possible to operate in three dimensions with great accuracy, and enables the mold 10 to be formed with the hollow mold cavity 12 inside the mold.

By way of example, the powder used is a powder-based Nylon®, wax, or metal, in particular a nickel-based alloy. The type of beam and its power are selected as a function of the powder used.

In the example of FIG. 2, the mold is fabricated as a single piece, with the blade mold cavity in negative in its central portion. Under such circumstances, in order to be used as a reusable mold, the mold is subsequently cut along a cutting line 14 so as to form two mold portions 11A and 11B, as shown in FIG. 3, each having half a blade mold cavity 13A and 13B. It may be understood that these two portions may be assembled in order to form the mold cavity there between, or separated for unmolding the blade formed in the mold cavity. FIGS. 2 and 3 show that the mold has a casting channel 15, e.g. formed as two respective portions 15A and 15B in each of the two mold portions, so as to enable the material for molding the blade to be introduced into the mold when the two portions are assembled.

Alternatively, it may be desired to make the mold immediately in the form of two (or more) mold portions suitable for being assembled in order to form the blade mold cavity 12 there between.

In order to obtain a mold that is reusable, it is preferable for the powder material subjected to the selected melting process to be Nylon® or a metal powder, e.g. a nickel-based superalloy.

Wax-type materials are preferred for fabricating a lost mold that is broken for unmolding the blade formed in the mold cavity.

Once the mold is available, it is possible to fabricate the turbine blade 16 shown in FIG. 4. If, as is advantageously so, the mold is reusable, then a plurality of blades may be made in succession in the same mold.

In order to fabricate the blade, a ceramic-based suspension is made initially, in particular a suspension of silicon nitride. For this purpose, ceramic particles are mixed with a binder, a dispersant, and water. The binder is a curable resin, preferably a monomer or a glycol. After the suspension has been injected or cast into the mold, the function of the binder during the gelation and then the drying of the suspension is to agglomerate the ceramic particles as a solid bulk. By way of example, the dispersant may be ammonium polyacrylate. Its function is to keep the ceramic particles in suspension in water prior to drying.

Before injection or casting into the mold, a hardening precursor is added to the suspension, in order to cross-link the binder.

The suspension, in the state of a pasty suspension, is introduced into the blade mold cavity inside the mold. Under the effect of the hardening precursor, the pasty suspension gelates so as to form a blade that is sufficiently solid (green body) to be capable of being extracted from the mold. Immediately after injecting or casting the suspension into the mold, the mold is degassed in order to eliminate any bubbles of air from the suspension, before significant gelation of the suspension.

After being extracted, the semi-solid blade is dried and then sintered.

With reference to FIGS. 5 and 6, there follows a description of the second embodiment of the invention. In this embodiment, it is a blade model 20 that is fabricated by selective melting on a powder bed, by using the above-described technique. As in the preceding embodiment, the material used for the powder that is subjected to selective melting may be a powder-based Nylon®, wax, or metal, and the type of beam and its power are selected as a function of the powder used.

Once this blade model is available, it is then possible to fabricate the mold. To do this, and as shown in FIG. 5, the blade model 20 is placed in an enclosure 22 and a polymer-based paste 24 is cast around the blade model. This paste is in particular a silicone-based polymer such as polydimethylsiloxane (PDMS). It also contains a cross-linking precursor that causes the mold to harden around the blade model.

Once the mold has reached the desired solid consistency, it is cut in order to obtain two (or more) mold portions 21A and 21B. These two portions may be separated as shown in FIG. 6 in order to enable the blade model 20 to be extracted. Thus, once the blade model has been extracted, two (or more) mold portions are obtained that may be assembled in order to form between them the mold cavity 12, like the two mold portions in FIG. 3 form between them the mold cavity when they are assembled. In parallel with cutting the mold block, a casting or injection channel is formed, e.g. in two portions 25A and 25B that are made respectively in each of the two mold portions 21A and 21B.

In the mold obtained in this way, the blade may be molded using a ceramic-based suspension, as described with reference to the first embodiment. The semi-solid blade (green body) may then be extracted from the mold, dried, and sintered as for the first embodiment.

For example, the suspension used in both embodiments to form the blade may be obtained as follows (where the values given serve to determine proportions).

The ceramic powder used is silicon nitride based powder, e.g. of the type sold under the reference Syalon® 050. To make a 125 milliliter (mL) suspension, 0.5086 grams (g) of Dispex® A-40 dispersant are mixed, which dispersant is based on ammonium polyacrylate. 3.75 g of Nagase ChemteX EX-810® resin are added to the mixture, then ethylene glycol diglycidyl ether acting as a binder, then 23 g of alumina grinding beads (e.g. spherical beads having a diameter of 5.2 mm), and the mixture is stirred for 30 minutes (min). Small amounts of Syalon® 050 powder are added in succession, and grinding is activated between each addition. For example, 23 g of Syalon® 050 powder is added followed by activating grinding for 4 hours (h), then a further 23 g of Syalon® 050 powder is added and grinding is activated for 10 h, and then 4.83 g of Syalon® 050 powder is added and grinding is activated for 2 h. At the end of this process, the suspension is screened in order to remove the grinding beads, and the hardening precursor is added. For example, the precursor may be bis(3-aminopropyl)amine. The quantity of hardening precursor is such that the weight ratio of resin to hardening precursor is 1 to 0.23. A suspension is thus obtained that is ready for casting in the mold in which the blade mold cavity has been formed.

In order to fabricate the blade, the suspension is injected into the mold, e.g. a PDMS mold obtained using the first or the second embodiment of the invention, and then the mold is degassed in order to eliminate bubbles of air. The gelation process then begins at ambient temperature around 18° C. to 22° C. After 24 h, the blade has solidified sufficiently to form a semi-solid blade or green body that may be unmolded. Unmolding is then performed either by breaking the mold or else, with a mold that is reusable, by separating the various portions of the mold. After eliminating the injection sprue, the semi-solid blade is transferred to an oven where it is subjected to a temperature of about 40° C. for a duration that is sufficient (e.g. of the order of 24 h) to dry the blade completely. Once the blade is dry, it is sintered.

1. A method of fabricating a ceramic turbine blade, the method comprising selective melting on a powder bed in order to obtain a blade mold cavity in a mold, a ceramic-based suspension is provided, wherein the suspension is introduced into the blade mold cavity, the suspension is subjected to a gelation step in the mold cavity in order to obtain a blade suitable for being extracted from the mold cavity, and said blade is extracted from the mold cavity.

2. A method according to claim 1, further comprising a step of fabricating the mold by selective melting on a powder bed, in order to obtain the blade mold cavity.

3. A method according to claim 2, wherein the mold is made as a single piece and said piece is cut into at least two mold portions suitable for being assembled in order to form the mold cavity there between, or for being separated for unmolding the blade formed in the mold cavity.

4. A method according to claim 2, comprising selective melting on a powder bed to make at least two mold portions suitable for being assembled to form the mold cavity there between, or for being separated for unmolding the blade formed in the mold cavity.

5. A method according to claim 1, wherein, in order to obtain the mold cavity, a blade model is made by selective melting on a powder bed, a polymer-based paste is cast around the blade model, said paste is caused to harden so as to form a mold block, the mold block is cut to obtain at least two mold portions enclosing the blade model, and said portions are separated in order to extract the blade model from the mold block, so that said portions may be assembled once more in order to form the blade mold cavity there between.

6. A method according to claim 5, wherein the mold block is cut by laser.

7. A method according to claim 1, wherein, after extracting the blade from the mold cavity, said blade is subjected to drying.

8. A method according to claim 7, wherein, after drying, the blade is subjected to sintering.

9. A method according to claim 1, wherein the ceramic base of the suspension is silicon nitride.

10. A method according to claim 1, characterized in that the powder to which selective melting on a powder bed is applied contains nylon, metal, or wax.
